(19) United States
(12) Patent Application Publication
(10) Pub. No.: US 2013/0319251 A1
(43) Pub. Date: Dec. 5, 2013

(54) AIR PURIFIER WITH NOISE CANCELLATION

(71) Applicant: Edwin Cheung, Monterey Park, CA (US)

(72) Inventor: Edwin Cheung, Monterey Park, CA (US)

(21) Appl. No.: 13/487,042

(22) Filed: Jun. 1, 2012

(51) Int. Cl. G10K 11/175; B01D 46/42

(52) U.S. Cl. 96/380

(57) ABSTRACT

A method and system for noise cancellation in an air purifier is disclosed. The air purifier employed with a noise cancellation system comprises at least one microphone connected to the air purifier. At least one microprocessor programmable and adaptable to operate with a noise cancellation software is connected in a way to receive signals from the microphone placed inside or near the air purifier. A plurality of speakers connected to the microprocessor outputs the noise cancelled sound waves. The system is adaptable to operate with any conventional air purification filters and is capable to achieve optimum effectiveness without generating undesirable noise. The frequency of the noise cancelling sound waves matches the frequency of unwanted sound.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

This invention relates to air purifiers, and more particularly to an air purifier with a noise cancellation system which is able to cancel the undesirable noise produced during air filtration.

Air purifiers are used to remove contaminants such as dirt, dust, smoke and other debris from the air and to provide a clean and refreshing breathing environment. There are several types of air purifiers and each one works using different methods. The different types of air filters are electric static purifiers, ionic purifiers, ozone generators, absorbent purifiers, and UV light purifiers. Air purifiers are used in hospitals, nursing homes, offices, commercial buildings, retail outlets, hotels, gymnasiums etc. These devices are commonly advertised as beneficial to allergy sufferers and asthmatics.

One prior art described in U.S. Pat. No. 6,036,757 issued to Gatchell on Mar. 14, 2000 defines a portable air purifier including a housing defining an air inlet, an air outlet and an air flow passage extending between the inlet and the outlet, a filter mechanism disposed to filter air circulating through the flow passage, a fan retained by the housing to draw air through the air inlet, moves air through the flow passage and filter mechanism and discharge air through the air outlet. An electrically powered drive mechanism is included to activate the fan and a control system includes a processor which monitors and records elapsed time data during periods in which the fan is activated to move air.

Another prior art described in U.S. Pat. No. 6,461,396 issued to Barker on Oct. 8, 2002 discloses an air purifying device for removing airborne particles. The device includes a housing containing an air inlet and an air outlet. A fan is positioned within the housing for drawing air into the housing through the air inlet and expelling air through the air outlet. A filter assembly is positioned within the housing between the air inlet and the fan. The filter assembly includes a frame and a filter element mounted to the frame. The device has a removable coupler having first and second hangers. A first elongate hanger support is coupled to the housing and removably extends within the first hanger and a second elongate hanger support is coupled to the frame and removably extends within the second hanger.

Another prior art taught in U.S. Pat. No. 7,241,326 issued to Han on Jul. 10, 2007 describes an air purifier including a filter which removes contaminants from air passing through. The invention includes a fan which generates a flow force to pass air through the filter, a rotating body rotatably mounted in the air purifier defining a flow path around the fan and a discharge direction of the flow path which varies depending on the rotation determined by the rotating body.

All of the systems and methods discussed above have a considerable drawback in that they make noise. Each produces a large volume of sound during filtration of air. The lack of a noise cancellation system in conventional air purifiers used in hospitals, nursing homes, offices, commercial buildings, retail outlets, hotels, and gymnasiums can often cause disturbance to the users.

Therefore, there is a need for a reliable noise cancellation system that can be applied to any conventional air purifiers to eliminate undesirable noise produced during the filtration of air. Such a needed system along with the air purifier can silently remove dirt and dust from the air to enhance the breathing environment of a user. The present invention accomplishes these objectives.

### SUMMARY

The preferred embodiment in accordance with the present invention is a noise cancellation system employed with a conventional air purifier. The noise cancellation system comprises at least one microphone connected to the air purifier. The air enters the air purifier and gets filtered. During the filtration of air, the air purifier produces undesirable noise and is fed to the microphone. The microphone converts the undesirable noise to the corresponding electrical signals At least one microprocessor programmable and adaptable to operate with the at least one noise cancellation software is connected in such a way as to receive signals from the microphone. The system is compatible to operate with microprocessors from any series and the noise cancellation software program of any version to cancel noise from the air purifier. The microprocessor employed with the noise cancellation software eliminates the noise and the output is fed to a speaker. The speaker sends noise cancelled sound waves, thereby freeing the air purifier from unwanted noise. The noise cancellation system can be applied to any size of air purifiers regardless of the airflow and particle size.

A method of cancelling undesired noise produced during the filtration of air utilizing a noise cancellation system is initiated by installing the noise cancellation system to an air purifier. The air gets filtered and the undesirable noise produced by the air purifier is transferred to a microphone. The microphone converts the undesirable noise to corresponding electrical signals. The electrical signals get transmitted to a microprocessor programmed with noise cancellation software. The noise cancellation software cancels the undesirable noise and the noise cancelled sound waves are produced at the output employing the speaker. The frequency of the noise cancelled sound waves matches the frequency of unwanted sound. The noise cancellation system is able to cancel noise produced by the air purifier preferably in a range of 90% to 99.9%.

### BRIEF DESCRIPTION OF THE FIGURES

FIG. 1 is a schematic diagram illustrating a system for noise cancellation employed with a conventional air purifier.

FIG. 2 is a flow chart illustrating a method of cancelling undesired noise produced during the filtration of air utilizing a noise cancellation system.

### REFERENCE NUMERALS

10 . . . System for noise cancellation employed with a conventional air purifier
12 . . . Noise cancellation system
14 . . . Air purifier
16 . . . Microphone
18 . . . Microprocessor with noise cancellation software
20 . . . Speaker
30 . . . Flow chart illustrating a method of cancelling undesired noise utilizing a noise cancellation system
32 . . . Employing a noise cancellation system to an air purifier
34 . . . Allowing the transfer of undesirable noise produced by the air purifier to a microphone
36 . . . Converting the undesirable noise to corresponding electrical signals
38 . . . Transmitting the electrical signals to a microprocessor programmed with a noise cancellation software
40 . . . Performing noise cancellation employing the noise cancellation software
42 . . . Outputting the noise cancelled sound waves utilizing a speaker

### DETAILED DESCRIPTION

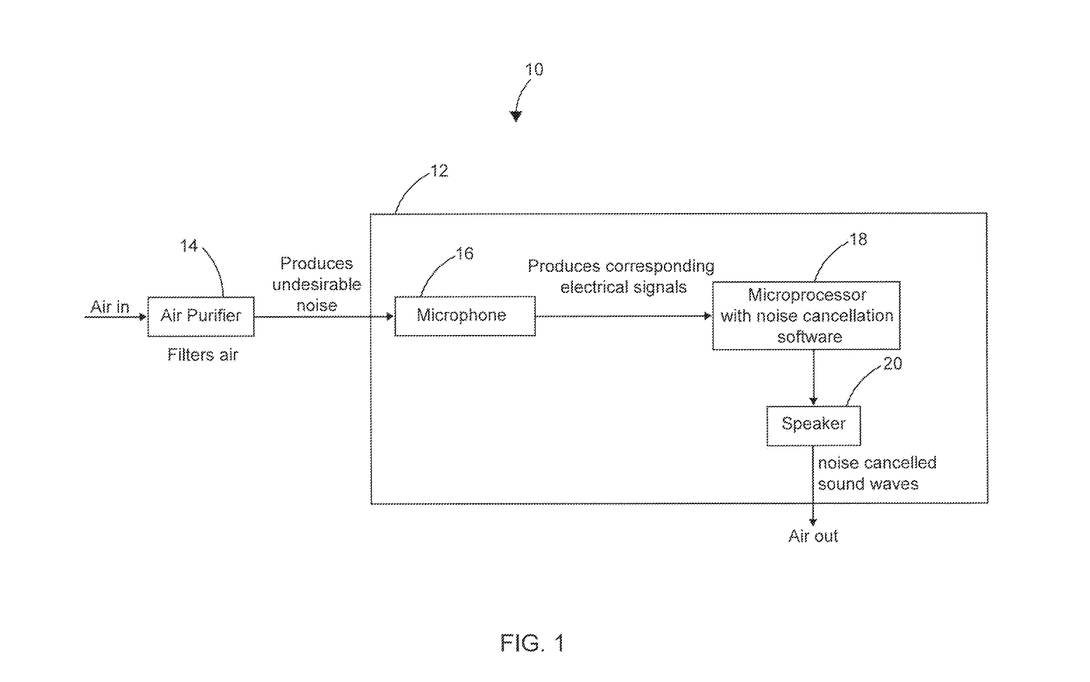

FIG. 1 shows a schematic diagram of a system for noise cancellation employed with a conventional air purifier 10. A noise cancellation system 12 comprises at least one microphone 16 connected to the air purifier 14. The air enters through the air purifier 14 and gets filtered. During the filtration of air, the air purifier 14 produces undesirable noise and is fed to the microphone 16. The microphone 16 converts the undesirable noise to corresponding electrical signals. The microphone 16 can be installed inside and/or outside of the air purified 14 to pick up all sound inside or near the air purifier 14. At least one microprocessor 18 programmable and adaptable to operate with the at least one noise cancellation software is connected in a way to receive signals from the microphone 16. The system 10 is compatible to operate with the microprocessor 18 from any series and the noise cancellation software program of any version to cancel noise from the air purifier 14. The microprocessor 18 employed with the noise cancellation software cancels noise and the output is fed to a speaker 20. The speaker 20 sends the noise cancelled sound waves which would be completely free from unwanted noise. The noise cancellation system 12 can be applied to any size of air purifiers 14 regardless of the airflow, i.e., low air flow or high air flow, and particle size.

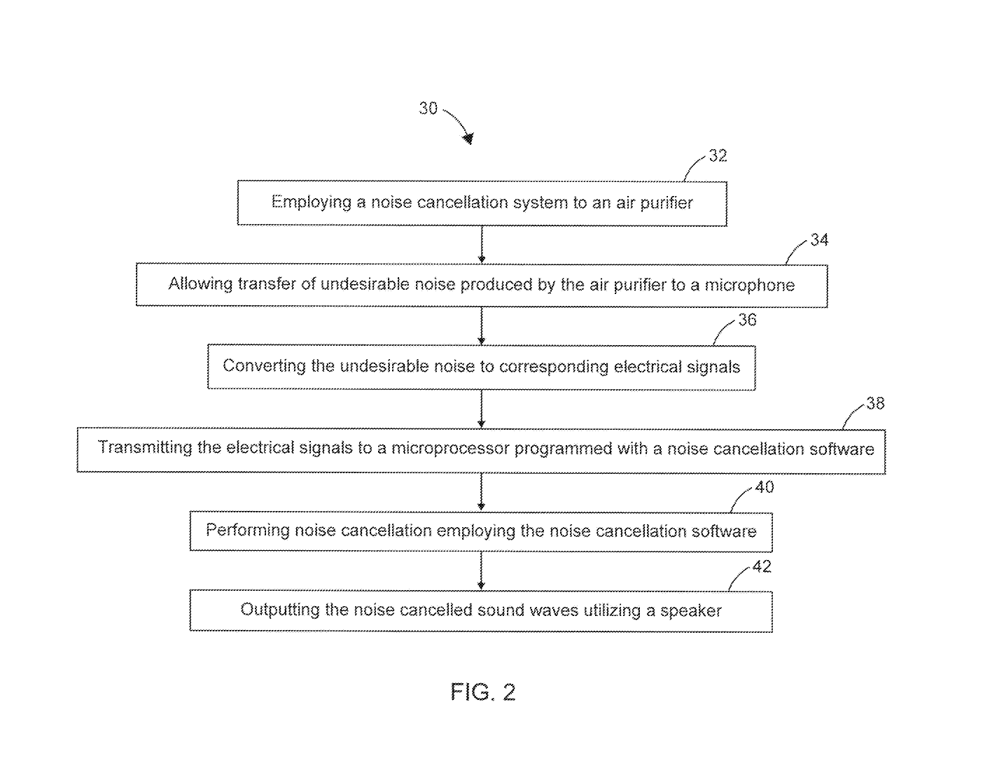

FIG. 2 is a flow chart illustrating a method of cancelling undesired noise produced during the filtration of air utilizing a noise cancellation system 30. As indicated at block 32, the process is initiated by employing the noise cancellation system to an air purifier. Then the undesirable noise produced by the air purifier is transferred to a microphone 34. The microphone converts the undesirable noise to corresponding electrical signals as shown at block 36. Electrical signals get transmitted to a microprocessor programmed with a noise cancellation software as shown at block 38. Thereafter, as indicated at block 40, the noise cancellation software cancels the undesirable noise and noise cancelled sound waves are produced at the output employing a speaker 42. The frequency of the noise cancelled sound waves match the frequency of unwanted sound. The noise cancellation system the system is able to cancel noise produced by the air purifier preferably in a range of 90% to 99.9%.

What is claimed is:

1. A noise cancellation system for cancelling undesired noise produced during filtration of air, the system comprising:
an air purifier;
at least one microphone connected to the air purifier;
at least one microprocessor programmed and adaptable to operate with at least one noise cancellation software to receive signals from the at least one microphone; and
a plurality of speakers connected to the microprocessor;
whereby the noise cancellation software is compatible to any conventional air purifier so as to achieve optimum effectiveness without generating undesirable noise.

2. The noise cancellation system of claim 1, wherein the at least one microphone captures and converts a sound signal to corresponding electrical signal.

3. The noise cancellation system of claim 1, wherein the at least one microphone is installed inside or outside of the air purifier.

4. The noise cancellation system of claim 1, wherein the system cancels noise produced by the air purifier preferably in a range of 90% to 99.9%.

5. The noise cancellation system of claim 1, wherein the system produces noise cancelling sound waves that match the frequency of unwanted sound.

6. A method for cancelling undesirable noise produced during filtration of air utilizing the noise cancellation system of claim 1, the method comprising the steps of:
a) installing the noise cancellation system to an air purifier;
b) utilizing a microphone for picki up the undesirable noise produced by the air purifier;
c) converting the undesirable noise to corresponding electrical signals;
d) transmitting the electrical signals to a microprocessor programmed with a noise cancellation software;
e) activating the noise cancellation software; and
f) outputting the noise cancelled sound waves utilizing a speaker.

7. The method of claim 6, wherein the frequency of noise cancelling sound waves matches the frequency of unwanted sound.

8. The method of claim 8, wherein the noise cancellation system is operable with any size of air purifier regardless of the airflow and particle size.

9. The noise cancellation system of claim 8, wherein the system is able to cancel noise produced by the air purifier preferably in a range of 90% to 99.9%.
